(19) United States
(12) Patent Application Publication
(10) Pub. No.: US 2022/0016774 A1
(43) Pub. Date: Jan. 20, 2022

(54) AUTOMATED SURFACE PREPARATION SYSTEM

(71) Applicant: 3M INNOVATIVE PROPERTIES COMPANY, St. Paul, MN (US)

(72) Inventors: Nicholas G. Amell, Minneapolis, MN (US); Jonathan B. Arthur, Hudson, WI (US); Thaine W. Fuller, Lakeland, MN (US)

(21) Appl. No.: 17/309,633

(22) PCT Filed: Dec. 18, 2019
(86) PCT No.: PCT/IB2019/061027

§ 371 Date: Jun. 11, 2021

Related U.S. Application Data
(60) Provisional application No. 62/781,874, filed on Dec. 19, 2018.

(51) Int. Cl. B25J 9/16; B24B 49/16; B25J 13/08; B25J 11/00

(52) U.S. Cl. CPC B25J 9/1664; B24B 49/16; B25J 9/1684; B24B 19/265; B25J 13/085; B25J 11/0065; B25J 13/088

(57) ABSTRACT

Automated systems and methods of using a smart end-effector tool to prepare (e.g., scuffing, abrading, sanding, polishing, etc.) an object surface are provided. The smart tool can update its working state with a robot arm in real time, which in turn adjusts locomotion parameters to optimize the tool's working state on the object surface.

### TECHNICAL FIELD

The present disclosure relates to an automated surface preparation system, and methods of making and using the same.

### BACKGROUND

Automotive industry needs to prepare surfaces of car parts or replacement parts (e.g., a bumper) for various purposes (e.g., painting). Typical surface preparation processes include, for example, physically abrading car surfaces, or “scuffing”. Current scuffing processes are generally labor intensive and create a significant amount of dust.

### SUMMARY

There is a desire to automate a surface preparation process such that an end-effector tool mounted on a robot arm can be isolated from clean air environment such as an auto part painting area. The present disclosure provides automated systems and methods of using a smart end-effector tool mounted on a robot arm to prepare (e.g., scuffing, abrading, sanding, polishing, etc.) an object surface.

In one aspect, the present disclosure describes an end-effector tool mounted on a motive robot arm for preparing an object surface. The tool includes a functional component configured to contact and prepare the object surface; one or more sensors configured to detect a working state of the end-effector tool, while the functional component contacts and prepares the object surface; and a control circuit to receive tool state signals from the sensors and process the signals to generate state information of the end-effector tool.

In another aspect, the present disclosure describes an automated surface preparation system including an end-effector tool and a motive robot arm. The tool is mounted on the motive robot arm. The tool includes a functional component configured to contact and prepare the object surface; one or more sensors configured to detect a working state of the end-effector tool, while the functional component contacts and prepares the object surface; and a control circuit to receive signals from the sensors and process the signals to generate state information of the end-effector tool.

In another aspect, the present disclosure describes a method of using a surface preparation system to prepare an object surface. The method includes providing an end-effector tool to a robot arm; initializing the system by communicating the tool with the robot arm to update the respective state information; while the end-effector tool contacts and prepares the object surface, detecting, via one or more sensors of the tool, a working state of the tool to generate tool state signals; processing, via a control circuit of the tool, the tool state signals from the sensors to generate real-time tool state information, notifications or instructions; transmitting the real-time tool state information, the notifications, or the instructions from the control circuit to a robot controller of the robot arm; and adjusting locomotion parameters of the robot arm and the tool's operation based on the real-time tool state information, the notifications, and the instructions.

Various unexpected results and advantages are obtained in exemplary embodiments of the disclosure. One such advantage of exemplary embodiments of the present disclosure is that an end-effector tool described herein can rapidly sample on-board sensors, distill the tool state signals and update real-time state information, notifications, and instructions to a robot control system to automatically and dynamically adjust or optimize the tool's working object interaction while the tool is preparing an object surface.

Various aspects and advantages of exemplary embodiments of the disclosure have been summarized. The above Summary is not intended to describe each illustrated embodiment or every implementation of the present certain exemplary embodiments of the present disclosure. The Drawings and the Detailed Description that follow more particularly exemplify certain preferred embodiments using the principles disclosed herein.

### BRIEF DESCRIPTION OF THE DRAWINGS

The disclosure may be more completely understood in consideration of the following detailed description of various embodiments of the disclosure in connection with the accompanying figures, in which:

FIG. 1 illustrates a side perspective view of a surface preparation system including a smart end-effector tool to scuff an object surface, according to one embodiment.

FIG. 2 illustrates a side perspective view of the smart end-effector tool of FIG. 1, according to one embodiment.

FIG. 3 illustrates a block diagram of a surface preparation system including a smart end-effector tool to scuff an object surface, according to one embodiment.

FIG. 4 illustrates a flow diagram of a method of using the surface preparation system of FIG. 3 to prepare an object surface, according to one embodiment.

FIG. 5 illustrates a cross-sectional view of a reconstructed bumper surface contour generated by using state information from an end-effector tool.

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

The present disclosure provides automated systems and methods of using an end-effector tool to prepare (e.g., scuffing, sanding, polishing, etc.) an object surface. An automated surface preparation system is provided to include an end-effector tool and a motive robot arm. The tool is mounted on the motive robot arm. The tool includes a functional component configured to contact and prepare the object surface; one or more sensors configured to detect working state information of the end-effector tool, while the functional component contacts and prepares the object surface; and a control circuit to receive signals from the sensors and process the signals to generate state information of the end-effector tool.

In some embodiments, an automated surface preparation system can initialize by communicating an end-effector tool with a robot arm thereof to update the respective state information. While the end-effector tool contacts and prepares the object surface, one or more on-board sensors of the tool can detect working state information of the tool to generate tool state signals. A control circuit of the tool can process the tool state signals from the sensors to generate real-time state information, notifications and instructions, and transmit the notifications and instructions to a robot controller, which can in turn adjust locomotion parameters of the robot arm based on the real-time state information and the notifications and instructions from the end-effector tool to adjust the tool's working state.

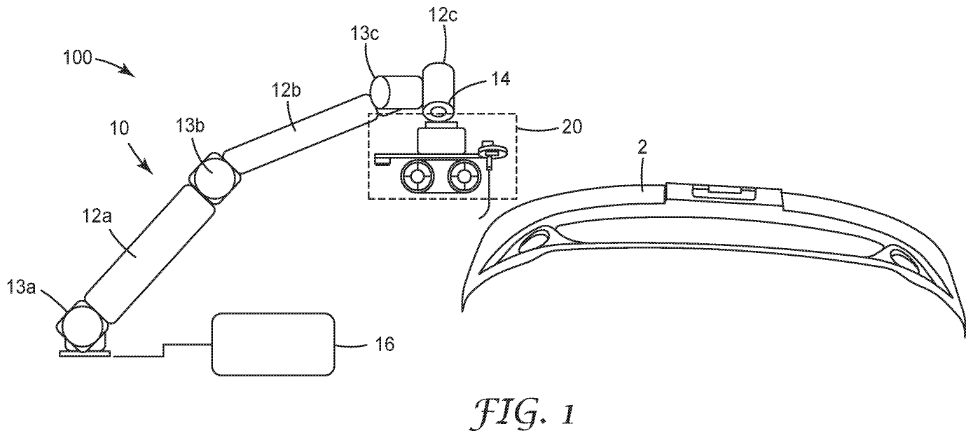

FIG. 1 illustrates a side perspective view of an automated surface preparation system 100 including a smart end-effector tool 20 to scuff an object surface 2, according to one embodiment. The surface preparation system 100 further includes a robot arm 10. The robot arm 10 includes multiple arm sections 12a-c connected by joints 13a-c. The smart end-effector tool 20 is functionally connected to a mounting interface 14 at the distal end of the robot arm 10. The mounting interface 14 may be designed based on certain mounting standards and compatible with various end-effector tools based on the same mounting standards. In some embodiments, the mounting interface 14 may include various mechanical and electrical means to functionally connect the tool 20 to the robot arm 10. For example, the mounting interface may include any suitable fastening device to mechanically mount the smart end-effector tool 20 onto the robot arm 10; the mounting interface may include any suitable electrical connections to communicate electrical signals between the tool and the robot arm or provide electrical power from the robot arm to the tool.

A robot controller 16 is used to execute a robot arm command program to control the locomotion of the robot arm 10 such that the movement trajectory of the smart end-effector tool 20 can be precisely controlled. In some embodiments, the robot arm command program may control the locomotion of the robot arm via a set of locomotion parameters including, for example, positions, orientations, velocities of the arm sections and joints. The object surface 2 can be, for example, an auto part surface (e.g., a bumper). The robot controller 16 can control the locomotion of the robot arm such that the end-effector tool 20 can contact and move around the object surface to prepare (e.g., scuffing, abrading, sanding, polishing, etc.) the object surface 2. In some embodiments, the robot controller 16 may include an optional power interface to a power source thereof to provide power to the end-effector tool in the form of electricity, pneumatic pressure, etc.

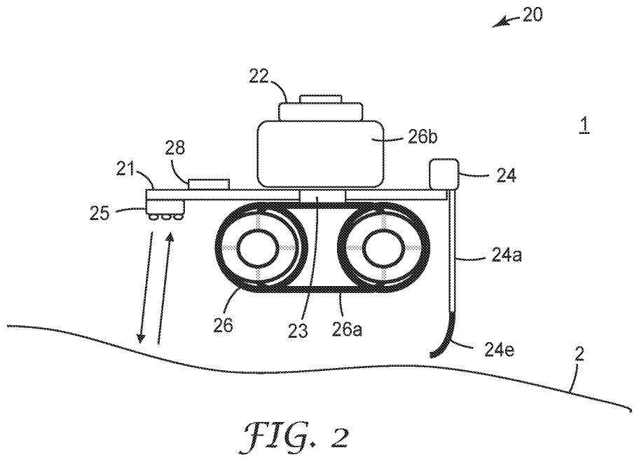

FIG. 2 illustrates a side perspective view of the smart end-effector tool 20 of FIG. 1, according to one embodiment. The smart end-effector tool 20 includes a mount interface 22 to mount the end-effector tool 20 onto the mounting interface 14 of the robot arm 10. The tool 20 is controlled by the locomotion of the robot arm 10 to adjust its position, orientation, movement trajectory, etc. when travelling around the object surface 2. In the depicted embodiment of FIG. 2, the smart end-effector tool 20 includes a functional component 26 configured to contact and scuff the object surface 2 of FIG. 1. The functional component 26 includes a scuffing pad 26a and a motor 26b to move the scuffing pad 26b to scuff or abrade an object surface. In some embodiments, the scuffing pad may include an abrasive pad. The abrasive pad can abrade the object surface, for example, by oscillating, vibrating, or moving in a certain trajectory under a certain pressure against the object surface.

The end-effector tool 20 further includes one or more sensors to detect working state information of the functional component 26, while the tool works or is about to work on the object surface 2. Related working state information may include, for example, displacement information between the functional component 26 and the object surface 2, mapping information of the object surface 2 including surface positions, planes, orientations, etc., physical contact information between the functional component 26 and the object surface 2 including, for example, contact pressure information, vibration information, etc. In the depicted embodiment of FIG. 2, the end-effector tool 20 includes a pressure sensor 23, a flex sensor 24, and an ultrasonic sensor 25 to detect the related working state information. It is to be understood that other suitable sensors can be used to obtain desired working state information of the end-effector tool. Also, multiple sensors can be distributed at various locations of the end-effector tool to monitor its working state.

The pressure sensor 23 can be positioned adjacent to the scuffing pad 26a to monitor the physical contact pressure between the scuffing pad 26a and the object surface 2. In the depicted embodiments of FIG. 2, the pressure sensor 23 is disposed between the scuffing pad 26a and a mounting board 21 of the scuffing pad 26a. In some embodiments, the pressure sensor 23 can be positioned between the scuffing pad 26a and the object surface 2 or other suitable locations as long as the physical contact pressure between the scuffing pad 26a and the object surface 2 can be monitored in real time.

The flex sensor 24 is provided to measure the exact displacement between the tool and the objection surface and continuously map the object surface 2, e.g., to obtain a 2D perspective representation or a contour of the object surface 2. The flex sensor 24 includes one or more flexible sensing elements 24a extending toward the object surface 2 and having the respective distal ends 24e to contact the object surface 2 to provide contact measurements of the exact displacement and continuous surface mapping. In some embodiments, the flex sensing elements 24a can be analog resistive and their resistance may change with the flexion amount thereof. The analog signals from the flexible sensing elements 24a can be amplified and sampled by a control circuit 28 in real time to generate surface mapping data for the object surface 2.

The ultrasonic sensor 25 is provided to measure the relative position of the end-effector tool 20 with respect to the object surface 2 as well as a continuous mapping of the object surface. The relative position can be measured by an echolocation process where sound waves can be transmitted from the ultrasonic sensor 25, bounced back from the object surface 2 and received by the ultrasonic sensor 25, with the time difference used to calculate the distance between the end-effector tool 20 and the object surface 2. The positioning signal of the ultrasonic sensor 25 can be sent to the control circuit 28 to determine a real-time displacement between and the end-effector tool 20 and the object surface 2. In some embodiments, the ultrasonic sensor 25 can provide the position and mapping information at a relatively coarse level which can be further refined by the measurement from a flex sensor and/or a pressure sensor.

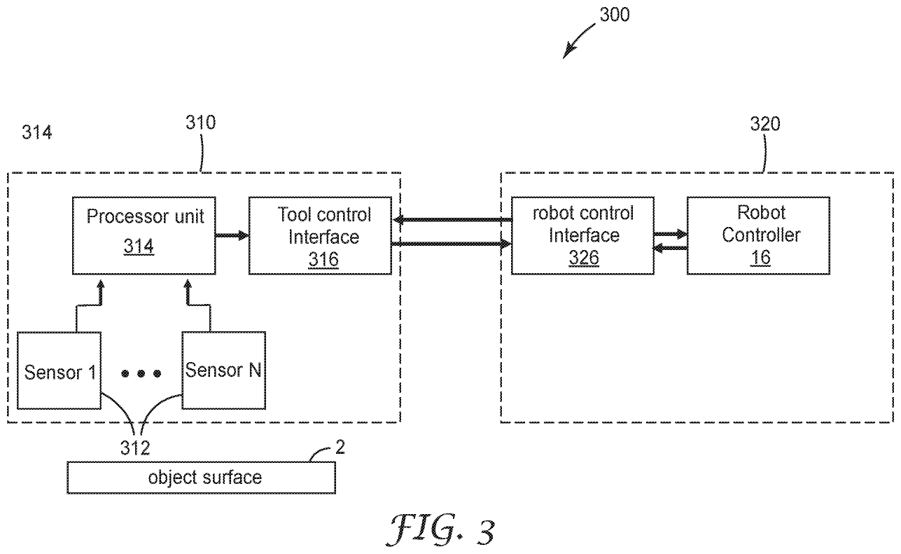

FIG. 3 illustrates a block diagram of a surface preparation system 300 including a smart end-effector tool 310 functionally connected to a motive robot arm 320 to prepare an object surface, according to one embodiment. The smart end-effector tool 310 includes multiple sensors 312 (e.g., Sensor 1, . . . Sensor N) to detect its working state information with respect to the object surface 2. The multiple sensors 312 can include, for example, one or more of the pressure sensor 23 of FIG. 2, one or more of the flex sensor 24 of FIG. 2, one or more of the ultrasonic sensor 25 of FIG. 2, one or more of other types of sensors, and any combinations of the sensors. Raw signals (e.g. analog sensor signals) from the sensors 312 are received and processed by a processor unit 314 (e.g., the control circuit 28 of FIG. 2). The processor unit 314 may include an analog-to-digital converter (ADC) component to sample analog sensor signals and convert the analog sensor signals to digital signals. The processor unit 314 may further include a digital signal processing component to process and distill the digital signals to generate real-time tool state information, notifications, or instructions, and communicate the generated information to the robot controller.

In some embodiments, the real-time tool state information generated by the processor unit 314 of the tool may include, for example, current position information of the tool with respect to the object surface. The real-time tool state information may further include, for example, a contact pressure indicating whether the tool contacting the object surface appropriately or not, a real-time change in the displacement between the object surface and the tool, etc.

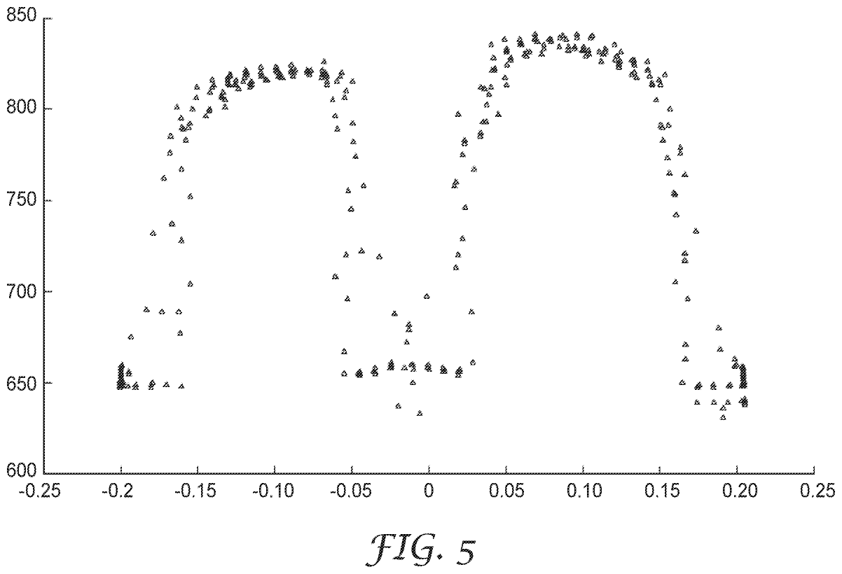

In some embodiments, the processor unit 314 can combine the positioning data from the ultrasonic sensor 25, the surface mapping data from the flex sensor 24 and the pressure data from the pressure sensor the microcontroller 23 to reconstruct the object surface 2 and derive a path for the end-effector tool to travel over the object surface 2 and prepare (e.g., scuff, abrade, sand, or polish) the object surface 2. FIG. 5 illustrates a cross-sectional view of a reconstructed bumper surface contour generated by the processor unit 314 based on the real-time state information, where the x axis is the position of the bumper surface and the y axis is the sensor displacement, both in relative units.

In some embodiments, the real-time notifications generated by the processor unit 314 of the tool may include, for example, position notifications (e.g., a notification to the robot controller that the tool is at an edge of the object surface), safety notifications (e.g., a notification to the robot controller that the contact pressure is above an upper limit), etc.

In some embodiments, the instructions generated by the processor unit 314 of the tool may include, for example, a tool-operation instruction regarding how to control the operation of the tool, a locomotion instruction to instruct the robot controller to adjust the position of the tool, or the movement trajectory or velocity of the tool, etc. A tool-operation instruction may include, for example, an on/off instruction to the robot controller to turn on/off the tool, a motor control instruction to the robot controller to control the operation of a motor of the tool, etc. For example, the processor unit 314 may send an instruction to the robot controller to instruct the robot arm to move away from the object surface when the processor unit 314 determines that the contact pressure is above a limit. The processor unit 314 may send an instruction to the robot controller to instruct the robot arm to reduce the speed of the tool movement when the processor unit 314 determines that the tool is approaching the object surface. The processor unit 314 may send an emergency stop instruction to the robot controller to stop the operation of the tool when the processor unit 314 determines that there is an emergency event (e.g., the tool is contacted by an unidentified protrusion in the object surface).

The real-time state information, notifications, or instructions from the smart end-effector tool 310 can be sent to the robot controller 16 via the tool control interface 316 and the robot control interface 326. The robot controller 16 can then use the real-time state information to simultaneously update the locomotion parameters of the robot arm such that the movement trajectory of the smart end-effector tool 310 can be precisely controlled. The robot controller 16 can also control the surface preparation system 300 accordingly by taking actions upon the notification or following the instructions from the smart end-effector tool 310. In some embodiments, the robot controller 16 may receive real-time state information, notifications, or instructions from the smart end-effector tool, interpret the received information, check whether the notifications or instructions are compatible with pre-set rules, and implement instructions correspondingly. For example, the robot controller 16 may provide the tool with a movement vector for the tool's position adjustment with respect to the object surface; the robot controller 16 may instruct the robot arm to provide an appropriate force to press the tool against the object surface; the robot controller 16 can provide an emergency stop command to the tool to stop when an emergency condition is determined by the robot controller, etc.

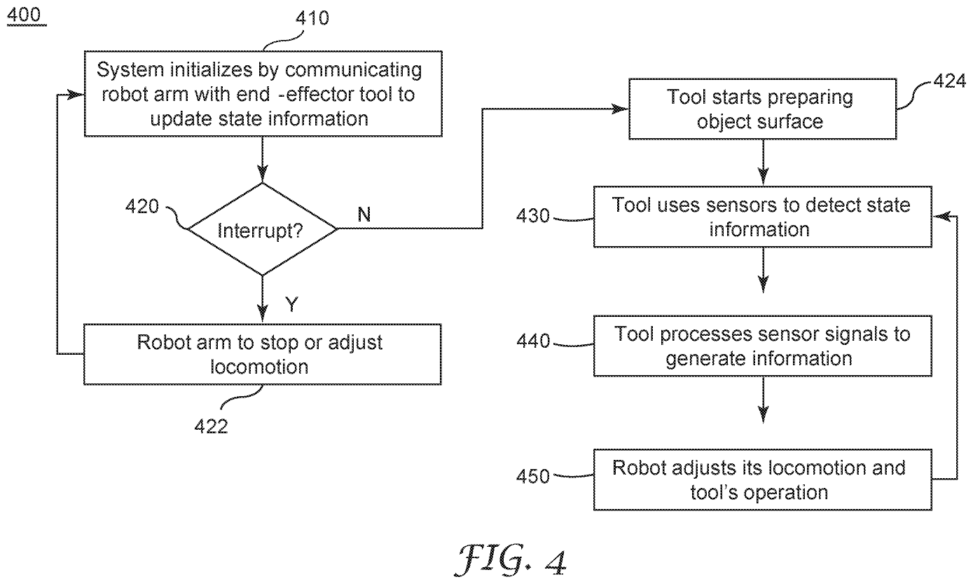

FIG. 4 illustrates a flow diagram of a method 400 of using a surface preparation system described herein (e.g., the surface preparation systems in FIGS. 1 and 3) to prepare an object surface, according to one embodiment.

At 410, the surface preparation system stars by initializing communication between a robot arm and an end-effector tool thereof. The robot arm (e.g., the robot arm 10 of FIG. 1) and the end-effector tool (e.g., the end-effector tool 20 of FIG. 2) of the surface preparation system communicate with each other to update the respective state information. Such respective state information may include, for example, power on self-tests (POST), starting orientations and coordinate systems, scuffing parameters (e.g. applied pressure, speed, etc.), and the like. The end-effector tool may receive state information of the robot arm from a robot control interface of the robot arm. The state information of the robot arm may include a set of locomotion parameters including, for example, positions, orientations, velocities of the arm sections and joints.

The end-effector tool can detect its own working state via the various sensors (e.g., the sensors 312 of FIG. 3) and determine at 420 whether to interrupt the initialization of the robot arm by sending notifications or instructions to the robot controller to stop or adjust the locomotion of the robot arm at 422. For example, in some embodiments, when the tool detects an emergency event, the tool can send notification to stop the initialization. In some embodiments, when the tool detects an object surface to be prepared, the tool can send instructions to the robot controller to adjust locomotion of the robot arm to position the tool at an initial position to prepare the object surface. When the end-effector tool determines not to interrupt the initialization of the system, the method then proceeds to 424 where the tool can start to prepare the object surface.

At 430, the end-effector tool uses its sensors to detect working state information of the end-effector tool with respect to the object surface, while the tool is moved by the robot arm and a functional component of the tool starts to contact and scuff the object surface. In some embodiments, a pressure sensor (e.g., the pressure sensor 23 of FIG. 2) can be provided to monitor the physical contact pressure between the tool and the object surface. In some embodiments, a flex sensor (e.g., the flex sensor 24 of FIG. 2) can be provided to map the object surface, e.g., to obtain a 2D perspective representation of the object surface. In some embodiments, an ultrasonic sensor (e.g., the ultrasonic sensor 25 of FIG. 2) can be provided to measure the relative position of the end-effector tool with respect to the object surface. The method 400 then proceeds to 440.

At 440, the end-effector tool processes, via a processor unit (e.g., the processor unit 314 of FIG. 3), the sensor signals to generate state information, notifications, or instructions and send the generated state information, notifications, or instructions to the robot controller. The robot controller receives the feedback from the end-effector tool and can take actions accordingly, e.g., to continuously update the locomotion parameters of the robot arm to adjust its locomotion and the tool's operation at 450.

At 450, the robot controller can adjust the locomotion parameters of the robot arm based on the received state information, notifications, or instructions from the tool and start a motion sequence defined by the adjusted locomotion parameters to precisely position a functional component of the tool along a pre-determined movement trajectory.

The method 400 can work in an iterative manner. An exemplary iterative process may star by moving the tool in a direction and continually detecting updates of working state from the tool. The tool, while measuring its working state including interaction properties between the tool and the object surface, can derive any state updates from the measurements, send the updates to the robot controller to adjust its locomotion and/or the tool's operation. This process continually repeats until the operation is complete. In this iterative manner, a surface preparation system described herein can automatically and dynamically control and operate a scuffing process to prepare an object surface.

The present disclosure provides automated systems and methods of using a smart end-effector tool to prepare (e.g., scuffing, abrading, sanding, polishing, etc.) an object surface. The smart end-effector tool allows for a localized data collecting and processing to detect working state information of the end-effector tool and update such a state awareness with a remote robot controller in real time. In some embodiments, such a state awareness can be updated with the remote robot controller many times a second which allows an instantaneous control of the locomotion of a robot arm based on the feedback from the end-effector tool. The smart end-effector tool can process and distill sensor raw signals to generate tool working state information, notifications, or instructions to the remote robot controller, which significantly reduces the amount of data being sent across to a centralized system. The systems and methods described herein can determine real-time tool state information within the context of control in complex situations that may not allow for a rapid response from the centralized system.

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Exemplary embodiments of the present disclosure may take on various modifications and alterations without departing from the spirit and scope of the present disclosure. Accordingly, it is to be understood that the embodiments of the present disclosure are not to be limited to the following described exemplary embodiments, but is to be controlled by the limitations set forth in the claims and any equivalents thereof.

### LISTING OF EXEMPLARY EMBODIMENTS

Exemplary embodiments are listed below. It is to be understood that any one of embodiments 1-13 and 14-21 can be combined.

Embodiment 1 is an end-effector tool mounted on a motive robot arm for preparing an object surface, the tool comprising:

a functional component configured to contact and prepare the object surface;

one or more sensors configured to detect a working state of the end-effector tool, while the functional component contacts and prepares the object surface; and

a control circuit to receive signals from the sensors and process the signals to generate state information of the end-effector tool.

Embodiment 2 is the tool of embodiment 1, wherein the functional component includes a scuffing pad and a motor to move the scuffing pad to abrade the object surface.
Embodiment 3 is the tool of embodiment 2, wherein the scuffing pad includes an abrasive pad.
Embodiment 4 is the tool of any one of embodiments 1-3, further comprising a mounting interface to functionally connect the tool to the motive robot arm.
Embodiment 5 is the tool of any one of embodiments 1-4, wherein the sensor signals include at least one of position data, pressure data, and surface mapping data.
Embodiment 6 is the tool of embodiment 5, wherein the sensors include at least one of an ultrasonic sensor to obtain the position data, a pressure sensor to obtain the pressure data, and a flex sensor to obtain the surface mapping data.
Embodiment 7 is the tool of embodiment 6, wherein the ultrasonic sensor is to emit an ultrasonic signal to monitor the displacement between the functional component and the object surface.
Embodiment 8 is the tool of embodiment 6 or 7, wherein the pressure sensor is positioned adjacent to the functional component to measure the contact pressure between the functional component and the object surface.
Embodiment 9 is the tool of any one of embodiments 6-8, wherein the flex sensor includes a flexible sensing element having a distal end to contact the object surface.
Embodiment 10 is the tool of any one of embodiments 1-9, wherein the control circuit includes a communication component to communicate signals between the control circuit and a control system of the motive robot arm.
Embodiment 11 is an automated surface preparation system comprising:

the end-effector tool of any one of embodiments 1-10; and

a motive robot arm, wherein the tool is mounted on the motive robot arm.

Embodiment 12 is the system of embodiment 11, wherein the motive robot arm further includes a microprocessor to execute a robot control system.
Embodiment 13 is the system of embodiment 12, wherein the control circuit of the tool communicates with the robot control system to update the state information.
Embodiment 14 is a method of using a surface preparation system to prepare an object surface, the method comprising:

providing an end-effector tool to a robot arm;

initializing the system by communicating the tool with the robot arm to update the respective state information;

while the end-effector tool contacts and prepares the object surface, detecting, via one or more sensors of the tool, a working state of the tool to generate tool state signals;

processing, via a control circuit of the tool, the tool state signals from the sensors to generate real-time tool state information, notifications or instructions;

transmitting the real-time tool state information, the notifications, or the instructions from the control circuit to a robot controller of the robot arm; and

adjusting locomotion parameters of the robot arm and the tool's operation based on the real-time tool state information, the notifications, and the instructions.

Embodiment 15 is the method of embodiment 14, wherein detecting the working state of the tool comprises using an ultrasonic sensor to obtain position data.
Embodiment 16 is the method of embodiment 14 or 15, wherein detecting the working state of the tool comprises using a pressure sensor to obtain pressure data.
Embodiment 17 is the method of any one of embodiments 14-16, wherein detecting the working state of the tool comprises using a flex sensor to obtain surface mapping data.
Embodiment 18 is the method of any one of embodiments 14-17, wherein the real-time tool state information includes one or more of a contact pressure, a displacement, and an object surface contour.
Embodiment 19 is the method of any one of embodiments 14-18, wherein the notifications include one or more of a notification of emergency event and a periodic state update.
Embodiment 20 is the method of any one of embodiments 14-19, wherein the instructions include one or more of a tool locomotion instruction and a tool operation instruction.
Embodiment 21 is the method of any one of embodiments 14-20, wherein the object surface is an auto part surface.

Reference throughout this specification to “one embodiment,” “certain embodiments,” “one or more embodiments,” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment,” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term “about.” Furthermore, various exemplary embodiments have been described. These and other embodiments are within the scope of the following claims.

1. An end-effector tool mounted on a motive robot arm for preparing an object surface, the tool comprising:
a functional component configured to contact and prepare the object surface;
one or more sensors configured to detect a working state of the end-effector tool, while the functional component contacts and prepares the object surface; and
a control circuit to receive signals from the sensors and process the signals to generate state information of the end-effector tool.

2. The tool of claim 1, wherein the functional component includes a scuffing pad and a motor to move the scuffing pad to abrade the object surface.

3. The tool of claim 2, wherein the scuffing pad includes an abrasive pad.

4. The tool of claim 1, further comprising a mounting interface to functionally connect the tool to the motive robot arm.

5. The tool of claim 1, wherein the sensor signals include at least one of position data, pressure data, and surface mapping data.

6. The tool of claim 5, wherein the sensors include at least one of an ultrasonic sensor to obtain the position data, a pressure sensor to obtain the pressure data, and a flex sensor to obtain the surface mapping data.

7. The tool of claim 6, wherein the ultrasonic sensor is to emit an ultrasonic signal to monitor the displacement between the functional component and the object surface.

8. The tool of claim 6, wherein the pressure sensor is positioned adjacent to the functional component to measure the contact pressure between the functional component and the object surface.

9. The tool of claim 6, wherein the flex sensor includes a flexible sensing element having a distal end to contact the object surface.

10. The tool of claim 1, wherein the control circuit includes a communication component to communicate signals between the control circuit and a control system of the motive robot arm.

11. An automated surface preparation system comprising:
the end-effector tool of claim 1; and
a motive robot arm,
wherein the tool is mounted on the motive robot arm.

12. The system of claim 11, wherein the motive robot arm further includes a microprocessor to execute a robot control system.

13. The system of claim 12, wherein the control circuit of the tool communicates with the robot control system to update the state information.

14. A method of using a surface preparation system to prepare an object surface, the method comprising:
providing an end-effector tool to a robot arm;
initializing the system by communicating the tool with the robot arm to update the respective state information;
while the end-effector tool contacts and prepares the object surface, detecting, via one or more sensors of the tool, a working state of the tool to generate tool state signals;
processing, via a control circuit of the tool, the tool state signals from the sensors to generate real-time tool state information, notifications or instructions;
transmitting the real-time tool state information, the notifications, or the instructions from the control circuit to a robot controller of the robot arm; and
adjusting locomotion parameters of the robot arm and the tool's operation based on the real-time tool state information, the notifications, and the instructions.

15. The method of claim 14, wherein detecting the working state of the tool comprises using an ultrasonic sensor to obtain position data.

16. The method of claim 14, wherein detecting the working state of the tool comprises using a pressure sensor to obtain pressure data.

17. The method of claim 14, wherein detecting the working state of the tool comprises using a flex sensor to obtain surface mapping data.

18. The method of claim 14, wherein the real-time tool state information includes one or more of a contact pressure, a displacement, and an object surface contour.

19. The method of claim 14, wherein the notifications include one or more of a notification of emergency event and a periodic state update.

20. The method of claim 14, wherein the instructions include one or more of a tool locomotion instruction and a tool operation instruction.
